(19) United States
(12) Patent Application Publication
(10) Pub. No.: US 2026/0093885 A1
(43) Pub. Date: Apr. 2, 2026

(54) SKEW BALANCING AMONG CIRCUIT SIGNAL PATHWAYS

(71) Applicant: TEXAS INSTRUMENTS INCORPORATED, Dallas, TX (US)

(72) Inventors: Tejas Salunkhe, Bangalore (IN); Subhadeep Aich, West Bengal (IN); Abhranil Bose, Kolkata (IN)

(21) Appl. No.: 18/923,131

(22) Filed: Oct. 22, 2024

(30) Foreign Application Priority Data
Sep. 27, 2024 (IN) 202441073059

(51) Int. Cl. G06F 30/3312; G06F 30/38; G06F 111/04; G06F 119/12

(52) U.S. Cl. CPC G06F 30/3312; G06F 30/38; G06F 2111/04; G06F 2119/12

(57) ABSTRACT

Provided herein are various enhancements for skew balancing in semiconductor circuits, such as during the synthesis, timing, routing, and phases of circuit design. In one example implementation, a method includes simulating a circuit to determine initial path delay values for a set of paths in the circuit, and determining a reference value for the set of paths based on the initial path delay values. The method also includes generating constraints using the reference value and a skew target for the set of paths, and performing a timing analysis to redesign the circuit using the constraints.

### RELATED APPLICATIONS

This application hereby claims the benefit of and priority to India Provisional Patent Application 202441073059, titled “NOVEL CORRECT-BY-CONSTRUCT PATH DELAY QUERY-BASED TECHNIQUE TO ENABLE DYNAMIC OPTIMIZATION FOR SKEW,” filed Sept. 27, 2024, which is hereby incorporated by reference in its entirety.

### TECHNICAL BACKGROUND

Skew indicates path-to-path variation in propagation timing among electrical signals, such as analog or digital signals carried along circuit paths. Improper skew balancing among signals, such as those of a data bus or designated sets of signals, can negatively impact performance or functionality of such circuits. While various techniques can be used to measure or determine skew, one common metric is a timing relationship relative to a clock signal or other designated reference signal. Skew imbalances can lead to suboptimal circuit design and operation, and skew imbalances can be especially pronounced when dealing with a large number of inter-related signals.

Mixed signal integrated circuit designs include analog domains and digital domains, including analog/digital conversion, radio frequency (RF) circuity, power regulators/converters, clock sources, sensing elements, and various digital logic and processing components. For mixed signal environments, among others, precise synchronization among analog/digital domains is often desired. For example, excessive skew in signal arrival times can lead to malfunction, data corruption, synchronization issues, or signal conversion inaccuracies when digital signals are converted to analog, and vice versa. Excessive skew can also introduce jitter or phase misalignment in analog signals generated from digital controls, impacting the quality of the analog output. Skew issues in the digital domain can also lead to spurious signals, crosstalk, and unwanted noise in the analog domain. For example, when clock signals used in analog circuits are out of phase with digital control signals, it can result in interference and signal degradation.

Existing approaches for integrated circuit signal skew management are typically employed using constraints applied within circuit design tools, such as in Electronic Design Automation (EDA) tools, which simulate or calculate path delays based on propagation delays, inline buffer elements, and other factors. These approaches are inefficient, and can lead to congestion, unmet design constraints, and long circuit processing times, among other problems. For example, an iterative process is typically employed to meet circuit design constraints. This iterative approach can encounter faults when too tight or too relaxed of constraints are used, or when many buffers/inverters and complicated path routing is required to meet design closure. Thus, unpredictable circuit simulation and design results are encountered, which does not scale well for larger quantities of circuit pathways in high-density integrated circuits, or across semiconductor process changes.

### SUMMARY

Provided herein are various enhancements for skew balancing in semiconductor circuits, such as during a circuit design flow encompassing synthesis, timing, placement, routing, and other various stages of circuit design. Specifically, a floating or dynamically determined reference value is established at each stage of circuit design flow before committing design optimization for a set of signals having a skew requirement. The floating reference can advantageously converge a set of paths to within a skew target across various flow stages to reach design closure. A reference value is determined based on initial path delay values for a set of circuit paths before optimization step of each stage of circuit design flow, and this reference value is applied to produce corresponding constraints for a subsequent design optimization stage of the design flow. The constraints can change with each flow stage, and thus enable the design tools to more effectively iterate over cell usage, path placement, routing, and layout to meet skew requirements.

In one example implementation, a method includes simulating a circuit to determine initial path delay values for a set of paths in the circuit, and determining a reference value for the set of paths based on the initial path delay values. The method also includes generating constraints using the reference value and a skew target for the set of paths, and performing a timing analysis to redesign the circuit using the constraints.

Another example implementation includes an apparatus having one or more non-transitory computer readable storage media and program instructions stored on the one or more non-transitory computer readable storage media. The program instructions are executable by a processing system to direct the processing system to at least simulate a circuit to determine initial path delay values for a set of paths in the circuit, and determine a reference value for the set of paths based on the initial path delay values. The program instructions can further direct the processing system to generate constraints using the reference value and a skew target for the set of paths, and perform a timing analysis to redesign the circuit using the constraints.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an example skew balancing environment in an implementation.

FIG. 2 illustrates example operations for a circuit design tool flow having a skew balancing system in an implementation.

FIG. 3 illustrates an example circuit with a skew balancing constraint in an implementation.

FIG. 4 illustrates an example circuit design tool flow having a skew balancing system in an implementation.

FIG. 5 illustrates example operations for a circuit design tool flow having a skew balancing system in an implementation.

FIG. 6 illustrates example results for a circuit design having enhanced skew balancing in an implementation.

FIG. 7 illustrates an example physical design system capable of implementing any of the physical design stages, sub-stages, or skew balancing systems discussed herein.

### DETAILED DESCRIPTION

Integrated circuit physical design can include use of software tools and computer-aided design environments, sometimes referred to as Electronic Design Automation (EDA) tools. These tools can process a schematic or descriptive representation of a circuit and produce various physical descriptions of the circuit for use in semiconductor manufacturing processes. EDA tools can include several incremental stages that handle corresponding portions of a design, including synthesis, floorplanning, clock tree synthesis (CTS), placement, or routing, as well as other portions of a design flow.

Initially, synthesis stages convert high level descriptions, such as schematic or logical descriptions, into a netlist having circuit-level representations and associated interconnect. Pre-CTS/floorplanning performs initial floorplanning of components, with initial placement of circuit components without regard to signal routing. Floorplanning takes a netlist and maps a logical description of the circuit design to a physical description within the bounds of a physical chip layout, and performs an initial placement of circuit blocks into a defined chip/core area.

Placement and routing continue the process of physical design. Placement determines locations of each circuit cell on a semiconductor die. Placement can also optimize a circuit physical layout and determine route-ability of interconnect for a circuit physical design.

Placement can be driven by signal timing, congestion, and power considerations. In routing stages, metal and vias are used to create the electrical connection in layouts defined by logical connections present in the netlist. Routing thus determines precise pathways for signals and interconnections of a circuit physical design.

Clock tree synthesis (CTS) stages can handle formation and timing analysis of clock trees, or a distribution network for clock signaling, which can include defining critical paths and ensuring clock signals arrive at various endpoints within defined margins. As a part of the CTS process, buffers or inverters can be added along a clock signal path to achieve synchronous operation or achieve clock skew targets. After CTS, the physical design includes information of placed circuit cells, blockages, clock tree elements, and input/output pins. This information is then used in forming the connections defined in the synthesized netlist.

During or after the aforementioned stages, various timing analysis, power optimization, and design rule checking can be performed. This can include determining signal path lengths and associated delays, estimated signal transit times, skew metrics, clock tree performance, estimated power draws, and checking the design against various design rules. Example checks include physical verification checks, timing analysis checks, logical equivalence checks, and other various design verification checks against design rules and electrical rules.

These checks can also include checks for minimum/maximum path lengths and skew targets, among other various circuit performance parameters. Once closure has been reached for a particular physical design, and all associated design checks have been satisfied, then a circuit can be considered ready for physical implementation and/or manufacturing. It should be noted that each manufacturing process might have additional flow stages, as well as flow stages specific to the selected semiconductor technology, chemistry, or process type.

Signal skew management can be implemented at any stage within a physical design flow, such as the various physical design stages mentioned above. Skew management can be used to balance or reduce signal skew among two or more signal pathways, which may be any type of signals. Skew constraints generally take the form of two categories, min/max constraints and relative window constraints. The min/max type of skew constraint places minimum or maximum signal propagation delays on individual signal pathways, and attempts to form circuit pathways that have signal path lengths between the minimum and maximum delay constraints in order to achieve skew targets. The relative window type of skew constraint designates a target pathway, such as a clock signal, and uses a timing window for that target pathway to attempt to form signal path lengths that lie within the timing window of signals carried by the target pathway.

Skew targets or constraints can be established within physical design tools, such as EDA tools. Existing approaches to skew management are inefficient, and can lead to congestion, unmet design constraints, and long circuit processing times, among other problems. For example, an iterative process is typically employed to meet circuit design constraints, where tools can simulate or calculate path delays based on signal propagation delays, compare these delays to constraints, and iteratively apply path changes to modify a design. This iterative approach can encounter faults when too tight or too relaxed of constraints are used, or when many buffers/inverters, large number of logic stages, and complicated path routing is required to meet design closure. Thus, unpredictable circuit simulation and design results are encountered, which does not scale efficiently for larger quantities of circuit pathways in high-density integrated circuits, and can lead to un-routable physical designs, especially when applied across different semiconductor process/types.

Provided herein are various enhancements for skew balancing in semiconductor circuits, such as during a circuit design flow encompassing synthesis, timing, placement, routing, and other various stages of circuit design. Specifically, a floating reference value is determined at each stage of circuit design flow for a set of signals having a skew requirement, also referred to as a skew target. The floating reference ensures a set of signals can have a skew relationship maintained across the various flow stages to reach design closure. A reference value is determined based on initial path delay values for a set of circuit paths, and this reference value is applied to produce corresponding constraints for a subsequent design optimization stage of the design flow. The constraints can change with each flow stage, and thus enable the design tools to more effectively iterate path placement, routing, and layout to meet skew targets.

The techniques of this disclosure can result in faster processes for the design of electrical circuits (e.g., quicker timing closure; quicker signoff closure), as compared to other design processes. Circuit designs that are outputted from these processes may have smaller die areas and/or tighter skews for the signal arrival times in the circuits. As just an example, there was a 53% reduction in the channel area of an interface between analog and digital circuits in work conducted by the inventors, when compared to other design approaches. The techniques of this disclosure can also reduce or eliminate the number of manual fixes performed by users in the design process. The design processes described herein are scalable, generic, and user friendly across many classes of circuits and can be implemented into EDA tools. Of course, these advantages are merely examples, and no advantage is required for any particular embodiment.

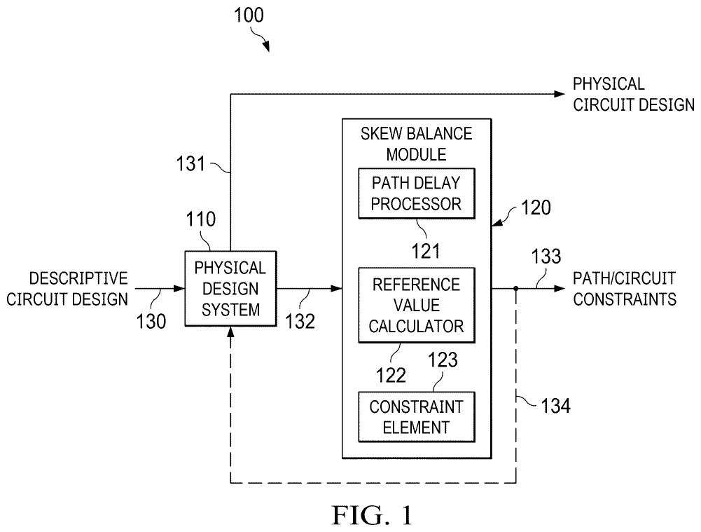

Turning now to a first example implementation, FIG. 1 is presented. FIG. 1 illustrates skew balancing environment 100, which includes physical design system 110 and skew balance module 120. Physical design system 110 produces outputs over interface 131, and is shown coupled to skew balance module 120 over interface 132. Skew balance module 120 produces an output over interface 133, and is shown optionally coupled to physical design system 110 over feedback interface 134. Skew balance module 120 includes path delay processor 121, reference value calculator 122, and constraint element 123.

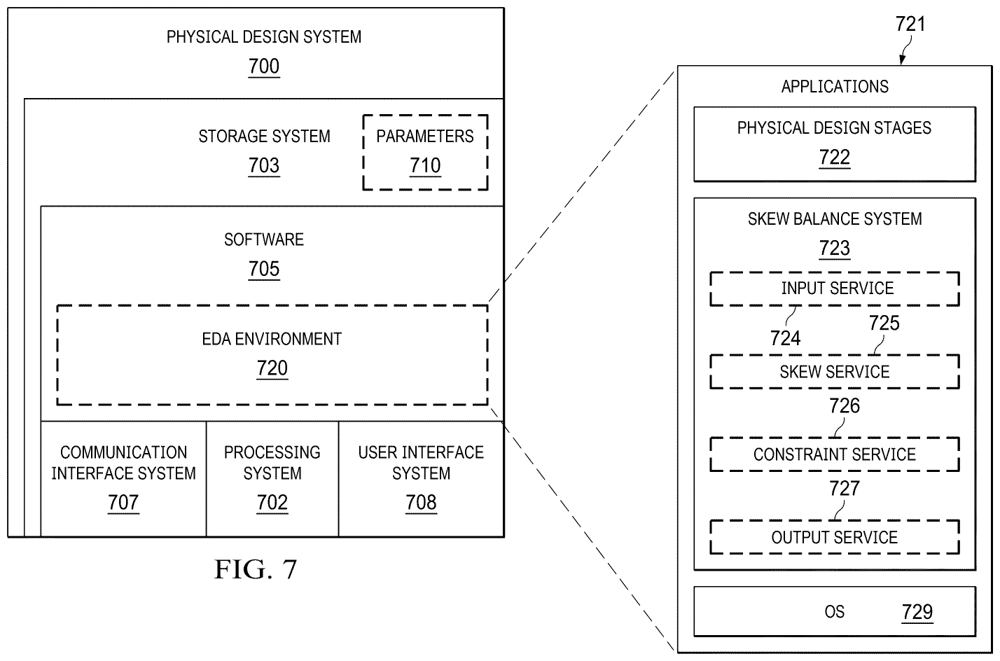

Various elements of FIG. 1 can comprise software elements executed by one or more processing elements (not shown). For instance, physical design system 110 and skew balance module 120, along with associated interfaces, can be implemented by executable program instructions stored on one or more computer-readable media. The program instructions, when executed by the processing elements, can direct the processing elements to at least operate according to the discussion below. FIG. 7 shows further example implementations of the software and processing elements of FIG. 1, in terms of an example computing system.

In operation, physical design system 110 can obtain a descriptive circuit design over interface 130, such as a schematic design, register transfer level design (RTL), or other circuit design representation, and produce a physical circuit design over interface 131. As a part of the physical design process, physical design system 110 can simulate a circuit at various stages to determine path delay values for a set of paths in the circuit. Skew balance module 120 can provide skew balancing functionality by way of delay processor 121, reference value calculator 122, and constraint element 123 to provide constraints for each stage of physical design system 110. With a skew target specified for a set of paths in a circuit, skew balance module 120 can enable physical design system 110 to achieve various skew requirements or targets, with iterative constraints for each physical design stage provided over feedback interface 134. These constraints can float or vary dynamically responsive to path delay values with each iteration, such that interim absolute min/max path delays achieve skew targets and more efficient physical design closure.

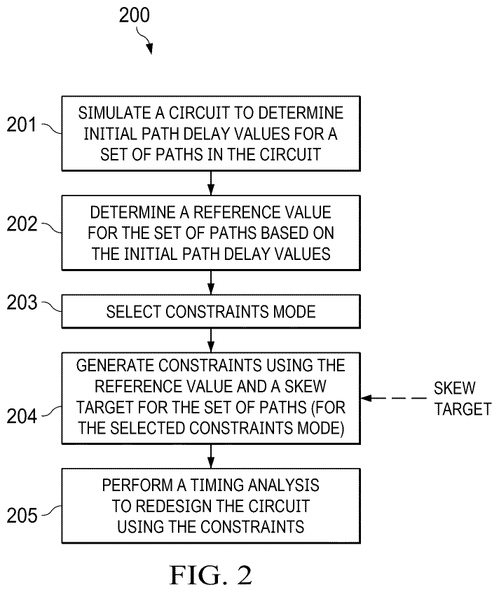

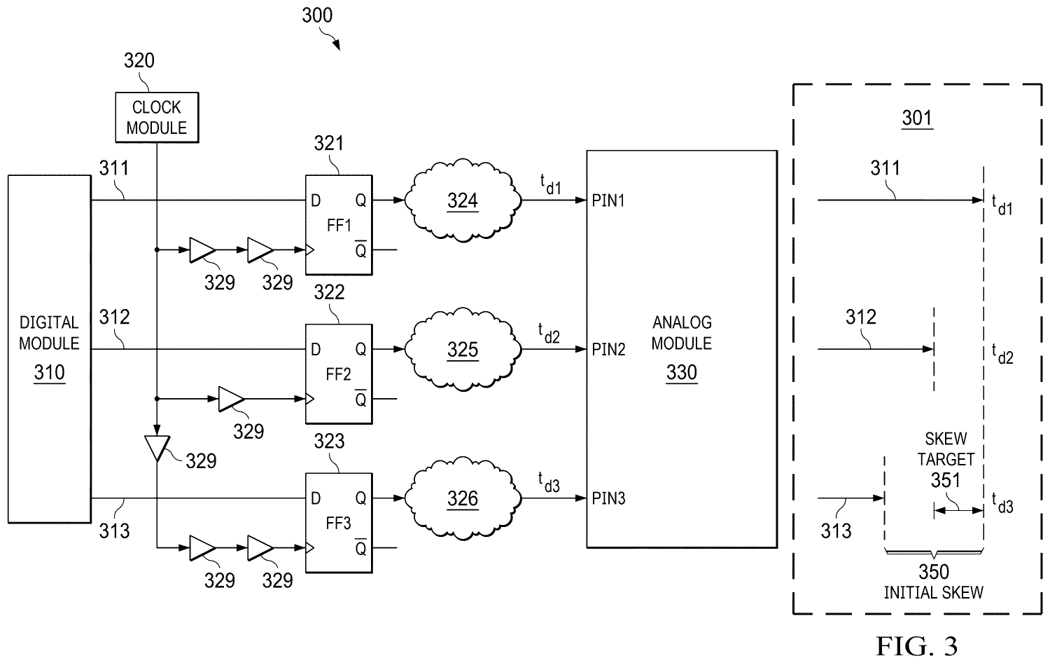

Turning now to a more detailed discussion on example operation of elements of FIG. 1, FIG. 2 is presented. Although the operations of FIG. 2 are discussed in the context of elements of FIGS. 1 and 3, it should be understood that these operations can apply to other example implementations discussed herein. FIG. 2 illustrates example operations 200 for a circuit physical design tool flow having skew balance module 120.

In operation 201, physical design system 110 simulates a circuit to determine initial path delay values for a set of paths in the circuit. A path delay value can refer to the propagation time for a signal to transit a particular circuit path between designated endpoints. While any example circuit could be employed, for purposes of discussion, FIG. 3 illustrates an example circuit 300 having a mixed signal configuration with an analog subcircuit and digital subcircuit. Circuit 300 is a mixed-signal circuit, but the techniques of this disclosure can apply to the design and verification of analog-only circuits or digital-only circuits. Circuit 300 is an example of a circuit that can be designed using the techniques of this disclosure and eventually fabricated/manufactured as part of an electronic device. Three example paths are included in circuit 300, namely paths 311-313 coupled between digital module 310 and analog module 330, with corresponding flip flops (FF) 321-323 and logic 324-326. Initial path delay values can be seen in detailed inset 301 (i.e., view 301) having td1 for path 311, td2 for path 312, and td3 for path 313, with each path having a different path delay value. These three path delay values correspond to initial skew 350, as measured between the minimum and maximum path delays. As can be seen in detailed inset 301, example skew target 351 is exceeded by initial skew 350.

Simulated path delays for example circuit 300 can arise at any stage within a physical design flow of physical design system 110, such as after synthesis, placement, floorplanning, routing, CTS, or other stages. Physical design system 110 can determine path delays by various techniques, such as estimated signal propagation times over conductive pathways, delays for circuit elements along a particular path, material properties, capacitance, inductance, and other factors. Thus, an initial set of values for path delays can be determined for paths 311-313 at any particular stage of a design flow, and these values can be provided over interface 132 to skew balance module 120.

Skew balance module 120 can obtain the initial path delay values, such as over interface 132. Path delay processor 121 might include portions of interface 132, and can pre-process the initial path delay values to scale, filter, place into data structures, or other operations. Path delay processor 121 can also provide the initial path delays to reference value calculator 122. In some examples, path delay processor 121 can comprise portions of physical design system 110 used to determine the initial path delay values.

In operation 202, reference value calculator 122 of skew balance module 120 determines a reference value for the set of paths based on the initial path delay values. The reference value can be determined using various techniques, which can be selected based on user input parameters, adjustable tool operational parameters, initial simulation value, and/or other factors. For example, various reference value techniques can be employed in parallel, and a best-fit value to a skew target can be selected as a final reference value. This disclosure refers to the determination of a reference value as a “floating” technique because the reference value calculator 112 can select a technique for determining the reference value depending on the initial circuit design (e.g., the initial path delay values). In addition, reference value calculator 122 can obtain path identifiers for a set of paths in a circuit with the initial path delay values. The path identifiers can be tags or metadata identifiers that correspond to individual paths, such that individual paths can be identified as having corresponding path delays throughout a skew balancing process.

In some examples, reference value calculator 122 determines the reference value using a lowest value of the initial path delay values, a mean value of the initial path delay values, or a highest value of the initial path delay values. In FIG. 3, a lowest value of the initial path delay values would correspond to td1, a highest value of the initial path delay values would correspond to td3, and a mean value of the initial path delay values would be a calculated mean determined among all three delay values (td1, td2, td3). The mean value can be calculated as an arithmetic mean or average (i.e., path delay sum divided by the number of paths), a geometric mean (i.e., multiplying path delays together and taking the root based on the number of paths), a gaussian mean, a trimmed mean removing outliers, histogram mean, or other techniques.

This reference value can be considered as a floating or variable reference value that can be updated after each stage of a physical design flow. A floating reference value might be determined at each stage of a physical design flow for a set of signals having a skew target.

The floating reference can provide a set of signals with a skew relationship maintained across the various flow stages to reach design closure. The floating reference also allows design constraints to change (or ‘float’) with each physical design flow stage, and thus enable the design tools to more effectively iterate over cell usage, path placement, routing, and layout to meet skew targets.

Once the reference value has been determined, then various path delay constraints can be determined for each of the paths affected by the skew target. The path delay constraints can include minimum/maximum path delay constraints established for each path, such that skew targets can be achieved for each path in stages of a physical design flow. In operation 203, constraint element 123 of skew balance module 120 selects a constraints mode, which indicates a technique used to translate the reference value into corresponding path delay constraints. The constraints modes can include a mean path delay mode, a minimum path delay mode, or a maximum path delay mode for generating the constraints, among others. As with the reference value, the constraints mode can be selected based on user input parameters, adjustable tool operational parameters, or other factors. In one example, constraint element 123 selects the minimum path delay mode responsive to a first threshold quantity of the initial path delay values being less than a mean value of the initial path delay values, or selects the maximum path delay mode responsive to a second threshold quantity of the initial path delay values being greater than the mean value.

For the selected constraints mode, in operation 204, constraint element 123 generates path delay constraints using the reference value and a skew target for the set of paths. A skew target can be determined based on a user input, input parameters, adjustable tool operational parameters, or other factors. The skew target can be specified in terms of a threshold value to be achieved, indicated in absolute time (seconds), percentage, relative measurements, or other metrics. The constraints can include a minimum path delay constraint or a maximum path delay constraint, which can be employed by physical design system 110 in subsequent physical design stages. Generating the constraints can include scaling the minimum path delay constraint or the maximum path delay constraint using the reference value and the skew target.

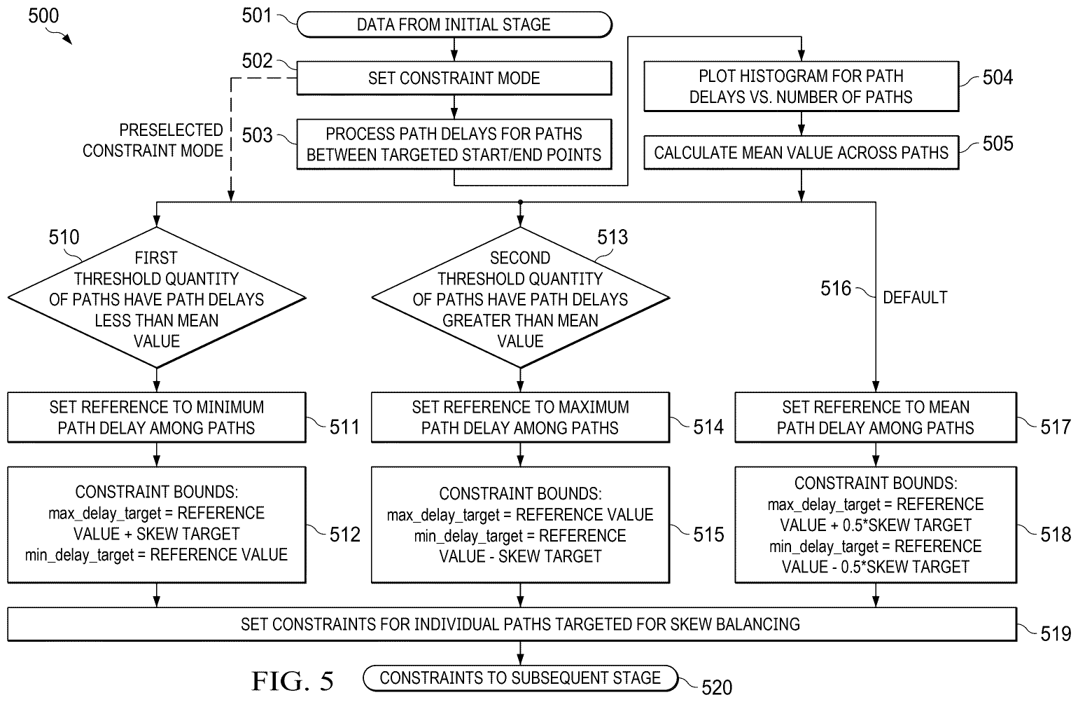

For the mean path delay mode, constraint element 123 can determine the maximum path delay constraint and the minimum path delay constraint using a first range for the reference value. For the minimum path delay mode, constraint element 123 can determine the maximum path delay constraint using a second range for the reference value and determining the minimum path delay constraint using a lowest value of the initial path delay values. For the maximum path delay mode, constraint element 123 can determine the minimum path delay constraint using a third range for the reference value and determining the maximum path delay constraint using a highest value of the initial path delay values. Further examples of these constraints and the various modes are illustrated in FIG. 5.

Once the constraints are determined, then skew balance module 120 can provide indications of the constraints for the path identifiers over interface 133. Interface 133 can include feedback interface 134 to provide the constraints to physical design system 110 for further iteration on a physical design or for use in subsequent stages of a physical design flow. In some instances, the constraints are provided on a per-path basis, and indications of the path identifiers are provided with corresponding constraints. In other examples, the constraints and path identifiers can be provided to other systems, modules, or elements over interface 133.

When physical design system 110 receives the constraints over feedback interface 134, then in operation 205, physical design system 110 can perform a timing analysis to redesign the circuit using the constraints. This redesign can include changing path lengths, changing cell usage on paths, or adding/removing buffers or inverters into the paths to achieve different path delay values to fit within the provided constraints. Since the reference value and constraints ‘float’ for each iteration of a design flow, then the skew target(s) can be advantageously achieved in fewer iterations or with better margins than other conventional physical design systems. Once closure has been achieved for a circuit or design, then specifications or descriptions of the physical design/circuit can be provided over interface 131. When employed in a semiconductor fabrication flow, these physical design descriptions or specifications can be employed in fabricating a semiconductor device including the redesigned circuit.

Returning to FIG. 3, paths 311-313 can have various path lengths, routing, buffers, inverters, or other circuit and elements included to achieve skew target 351. Additionally, FIG. 3 shows clock tree 321 originating from clock module 320, which is distributed to flip flops 321-323. Various clock tree balancing is shown in FIG. 3 by way of buffers 329, which might achieve arrival time targets or skew targets for a clock tree. However, in contrast to skew in arrival times of for a single signal, like a clock signal distributed to many destinations, the skew balancing operations discussed herein can achieve skew targets for many different signal paths irrespective of the signaling carried thereon. Data buses, individual signals, analog or digital signaling, clock-to-data relationships, and other various paths can be included in a group or set for which skew targets can be achieved. FIG. 3 shows paths 311-313, which might comprise a data bus, data signals, or other digital signals coupled between digital module 310 and analog module 330.

Advantageously, the operations and elements of FIGS. 1-3 discussed above can overcome conventional skew limitations that provide inefficient area optimization, especially in analog-digital interface channels. The examples herein provide iterative processes to reach skew targets using floating min/max constraints on signal paths. These floating constraints, provided by a floating reference value determined across each stage of a design flow, can overcome sensitivities of EDA tools to high-density floorplanning and placement, require fewer iterations to reach design closure, and can be scalable across designs and across semiconductor technologies, feature sizes, and materials.

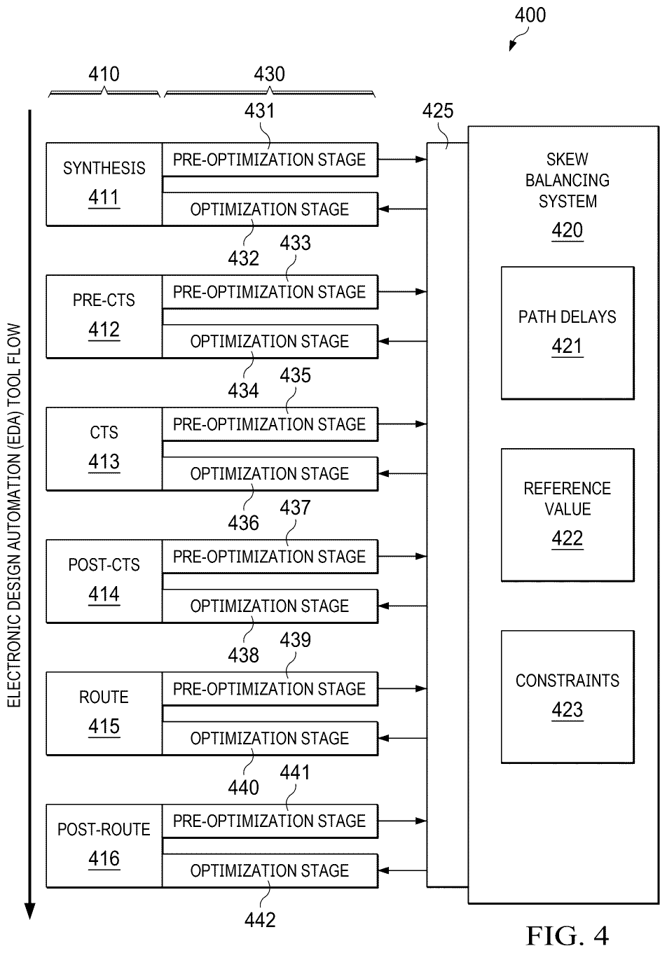

FIG. 4 illustrates an example circuit design tool flow 400 having a skew balancing system in an implementation. Tool flow 400 comprises several stages 410, each with corresponding sub-stages 430. Each sub-stage 430 can interface with skew balancing system 420 in FIG. 4 over an associated interface 425. Stages 410 include stages 411-415, namely synthesis stage 411, pre-CTS stage 412, CTS stage 413, post-CTS stage 414, route stage 415, and post-route stage 415. Each stage can handle a portion of a physical design flow for an integrated circuit, such as to establish a physical design description for manufacturing a semiconductor device comprising one or more circuits. The exact configuration and arrangement of stages can vary based on implementation, and stages 410 in FIG. 4 are included as one example.

In addition, each stage comprises sub-stages (431-442) which include pre-optimization sub-stages and optimization sub-stages. A pre-optimization sub-stage can provide descriptions related to path delays to skew balancing system 420 over interface 425. These path delays typically comprise a set of electrical paths or routes for a circuit being processed by stages 410, along with identifiers for such electrical paths. An optimization sub-stage can receive constraints from skew balancing system 420.

In operation, a physical design system represented by stages 410 can obtain a descriptive circuit design, such as a schematic design, RTL, or other circuit design representation, and produce a physical circuit design for use in manufacturing. As a part of the physical design process, stages 410 can simulate a circuit at the various stages to determine path delay values for a set of paths in the circuit. Skew balance system 420 can provide skew balancing functionality by way of modules 421-423 to provide constraints for each stage of tool flow 400. With a skew target specified for a set of paths in a circuit, skew balance system 420 can enable tool flow 400 to achieve various skew requirements or targets, with successive or iterative constraints for each physical design stage 411-415 provided over feedback interface 425. These successive constraints can float or vary with each iteration, such that interim absolute min/max path delays achieve skew targets and more efficient physical design closure.

Elements 411-415, 420-425, 431-442 each can comprise software elements executed by one or more processing elements, such as those discussed below in FIG. 7. For instance, elements 411-415, 420-425, 431-442, along with associated interfaces, can be implemented by executable program instructions stored on one or more computer-readable media. The program instructions, when executed by the processing elements, can direct the processing elements to at least operate according to the discussion herein.

Turning now to example operations for elements of tool flow 400, FIG. 5 is presented. FIG. 5 illustrates example operations 500 for circuit design tool flow 400 having skew balance system 420 in an implementation. The operations of FIG. 5 can be applied to other example systems, such as elements of FIG. 1 or FIG. 7. Also, FIG. 4 shows many stages of an example tool flow. The operations of FIG. 5 can apply to each stage 411-415, as shown for individual pre-optimization sub-stages and optimization stages. Thus, the discussion below for FIG. 5 omits specific references to specific stages for clarity, and instead can apply to any or all stages of tool flow 400.

First, data is provided by an initial physical design stage at operation 501. This data can include initial path delay values for a set of paths of a circuit. The paths typically correspond to ones for which a skew requirement or skew target is applicable, and indicate circuit paths between targeted start/end points. As discussed herein, the skew target can be obtained, queried, or distributed from various sources, such as user-applied targets, circuit operational requirements, configuration files, setup scripts, design rules, or other sources. The initial path delay values can be indicated in a file, as a data structure, over an API, queried, or using various interface or data sharing techniques, and indicate identifiers for each path as well as a path delay value associated with each path. The path delay values can be indicated in terms of a time in seconds or other units, but can instead have alternative representations including path length. In the context of FIG. 4, interface 425 of skew balancing system 420 can receive this data indicating the initial path delay values from any pre-optimization stage.

One example can include a data structure, such as parameter file or Extensible Markup Language (XML) structured file data structure that carries this data. For instance, the data structure can include a “min/max/mean” parameter to provide flexibility to select between three algorithms used to calculate a floating reference value; a “skew_required_value” that specifies the skew balancing requirement value (e.g., skew target value); a “skew_sigma_value” or “skew_window_adj” that provides flexibility to adjust a skew value or window around a reference value (referred to as a ‘range’ herein); a “combinational_from_to” used to ignore clock latency and consider path delay only between provided points; “path_identity” parameters indicating paths between which skew is targeted to be balanced, among other parameters. The “path_identity” parameters can be selected using multiple options and variation of -from* and -to* or tag: tag_name, among other path identities or path identifier formats.

In operation 502, constraints module 423 sets a constraint mode corresponding to a mode of determining path constraints for output to a subsequent physical design stage. The constraint mode can be selected among at least a mean path delay mode, a minimum path delay mode, or a maximum path delay mode for generating path constraints, among other modes. In some examples, a user or operator might select this mode, or a set of configurable parameters can select this mode, as indicated by the “preselected constraint mode” in FIG. 5. In other examples, this mode can be selected dynamically based on a mean value of the initial path delay values compared to the initial path delay values themselves. This dynamic mode selection can correspond to operations 510, 513, and 516, and constraints module 423 can select the minimum path delay mode responsive to current values for initial path delay values and mean values thereof. For example, selecting a first threshold quantity (e.g., >70%) of the initial path delay values being less than a mean value of the initial path delay values, and selecting the maximum path delay mode responsive to a second threshold quantity (e.g., >70%) of the initial path delay values being greater than the mean value. Other threshold values can be employed. Also, a default operation 516 can be employed when neither of the first threshold quantity or second threshold quantity is met or selected.

However, before path constraints are determined, a reference value is determined that relates to the initial path delay values. In operation 503, path delays module 421 processes path delays for paths between targeted start/end points. In one example, path delays are normalized or scaled to suit a selected unit or timescale for use in subsequent operations. In other examples, the path delay values can be added to a data structure or altered to a selected data format to aid reference value calculations or operations. In operations 504-505, reference value module 422 plots a histogram for the initial path delay values vs. a number of paths, and calculates a mean value across the initial path delay values. This histogram can be employed, among other techniques, to determine a mean value, or perform other arithmetic or geometric operations to determine a mean value based on the initial path delay values. The mean value can be calculated as an arithmetic mean or average (i.e., path delay sum divided by the number of paths), a geometric mean (i.e., multiplying path delays together and taking the root based on the number of paths), a gaussian mean, a trimmed mean removing outliers, histogram mean, or other values.

Once a mean value is determined, constraints module 423 can apply this mean value (along with the initial path delay values) to a preselected constraint mode or to various dynamic mode thresholds. For the dynamic mode selection, constraints module 423 can select a minimum path delay constraints mode in operation 510 responsive to a first threshold quantity of the initial path delay values being less than the mean value of the initial path delay values. In operation 513, constraints module 423 can select a maximum path delay constraints mode responsive to a second threshold quantity of the initial path delay values being greater than the mean value. If none of these criteria are met, then operation 516 includes a default path delay constraints mode.

For the minimum path delay constraints mode selection of operation 510, reference value module 422 can set a reference value to a minimum or lowest path delay among the initial path delay values (operation 511). For the maximum path delay constraints mode selection of operation 513, reference value module 422 can set the reference value to a maximum or greatest path delay among the initial path delay values (operation 514). In operation 517, for the default path delay constraints mode selection of operation 516, reference value module 422 can set the reference value to the mean value (determined previously in operation 505). Thus, in some examples, the reference value is determined using a lowest value of the initial path delay values, a mean value of the initial path delay values, or a highest value of the initial path delay values. The reference value comprises a dynamic value determined based on various criteria, such as the mean value among the initial path values, and various properties of the initial path delay values, such as threshold quantities over/under the mean value.

From here, the reference value is employed to determine path constraints for a subsequent physical design stage for the circuit that includes the paths indicated by the initial path delay values. Specifically, for the mean path delay mode (i.e., default mode at operation 516), constraints module 423 can determine a maximum path delay constraint (max_delay_target) and the minimum path delay constraint (min_delay_target) using a first range or window about the reference value. This range or window is indicated in FIG. 5 as [0.5*skew target], but other ranges can be employed, including unequal ranges and configurable ranges. Thus, operation 518 shows one example having max_delay_target as the reference value+[0.5*skew target], and a min_delay_target as the reference value−[0.5*skew target]. Other windows or ranges can be employed, such as a maximum window of 0.33, a minimum window of 0.33, and a mean window of 0.5.

For the minimum path delay mode (i.e., criteria met at operation 510), constraints module 423 can determine the maximum path delay constraint using a second range for the reference value and determine the minimum path delay constraint using a lowest value of the initial path delay values. Specifically, operation 512 indicates a max_delay_target as the reference value+the skew target, and a min_delay_target as the reference value. While this example uses the skew target as the second range, other range values can be employed.

For the maximum path delay mode (i.e., criteria met at operation 513), constraints module 423 can determine the minimum path delay constraint using a third range for the reference value and determine the maximum path delay constraint using a highest value of the initial path delay values. Specifically, operation 515 indicates a max_delay_target as the reference value, and a min_delay_target as the reference value-the skew target. While this example uses the skew target as the third range, other range values can be employed.

Once the path constraints are determined (max_delay_target and min_delay_target), these path constraints can be set for individual paths targeted for skew balancing in operation 519. Setting the path constraints for individual paths targeted for skew balancing can include constraints module 423 identifying individual paths identified in operation 501, such as by accompanying path identifiers, metadata, identification numbers, identities, or other indicators. Then the max_delay_target and min_delay_target constraints can be applied to each path via a corresponding path identifier. A suitable data structure, API format, table, markup format, or other format can be employed that houses the constraints and path identifiers.

Finally, the constraints can be provided to a subsequent physical design stage (operation 520). The subsequent physical design stage typically employs these constraints to redesign, reconfigure, re-time, or otherwise alter the affected circuit to attempt to meet the constraints. By floating the reference value in FIG. 5, as well as providing various constraint mode selections, a selected skew target for a set of circuit paths can be more effectively achieved by the subsequent physical design stage. “Floating” the reference value refers to selecting the reference value using operation 510, operation 513, or operation 516, depending on the conditions of the initial physical design stage. This is in contrast to a so-called fixed reference value that is based on the same operation for each design iteration, for example, setting the reference value to a mean or median path delay. A design approach implementing a fixed reference value uses the same reference-value formula for each design iteration; e.g., every design uses the mean path delay as the reference value.

In prior approaches, a fixed reference signal/path is used for skew balancing throughout physical design stages, which can result in high drive cell usage on slower signals and delay buffer additions on faster signals, incurring unwanted area penalties. This may result in congestion and timing closure challenges in analog-digital interface channels. In contrast to the prior approaches of using a fixed reference signal/path, the enhanced examples herein use an adaptive approach to detect more optimal reference values and use floating reference values for path constraints. The examples herein also can employ path delays before optimization sub-stages of each physical design stage, calculate a reference value, and create path constraints based in part on that reference value. Through this dynamic selection of a reference value before each optimization sub-stage of a physical design flow, the examples herein can ensure that enough scope is provided for physical design tools to achieve skew timing. Moreover, this methodology of dynamic reference value selection can be integrated as part of the constraints during optimization sub-stages, which help to achieve a first pass skew timing closure. Circuits having multiple buses/channels which require skew balancing can benefit from the area savings of this approach helping in mitigation of congestion in interface channels, and can also benefit by providing predictability in timing closure of critical skew requirements-thus avoiding last mile design changes.

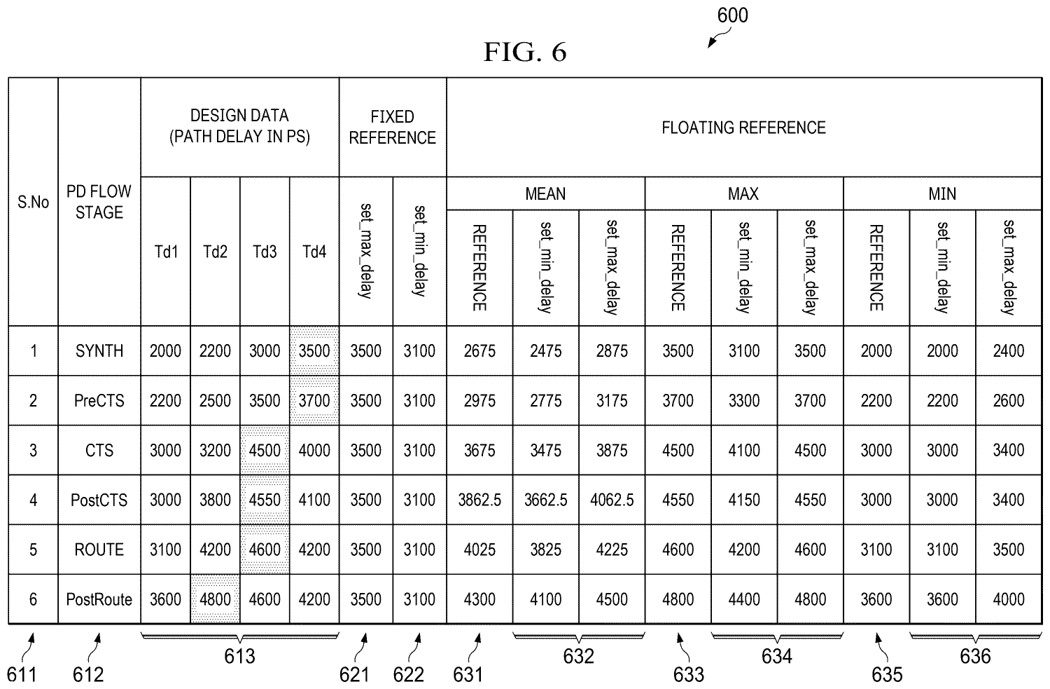

FIG. 6 illustrates example results table 600 for a circuit design having enhanced skew balancing in an implementation. Table 600 compares results using a fixed reference value for skew management to results using a floating reference value instead. The enhanced floating reference value discussed herein can be based on various factors, including initial path delay values and a skew balancing mode, among other considerations.

A portion of table 600 indicates a stage number (column 611) among a plurality of example physical design stages (column 612). Four paths are considered in this example, which can form a set of paths used in a circuit, for which skew targets are applied. Path delay values for these paths are indicated in columns 613 as a time delay (Td) in picoseconds (ps) for each of the stages. As can be seen by the various rows, an iterative or successive stage approach is illustrated, where each stage (row) has a corresponding set of path delay values for each path. Highlighted path delays indicate a greatest path delay value in each row. These example path delay values (613) in table 600 can correspond to the initial path delay values discussed herein, on a per-stage basis.

Now, table 600 shows columns 621-622 corresponding to a conventional fixed reference configuration, and columns 631-636 corresponding to an enhanced floating reference configuration. Column 612 indicates set_max_delay and set_min_delay constraints which correspond to fixed path delay (in ps) constraints for each individual stage. As discussed herein, having a fixed constraint/reference can lead to various disadvantages, including excessive circuit design times, inability to obtain circuit design closure, excessive congestion, and difficulty in routing affected signal paths, among other disadvantages.

However, columns 631-636 illustrate an enhanced floating reference configuration, which can alter the reference value and corresponding constraints for each stage (row) noted in table 600. Specifically, three modes of operation can be employed, with one mode typically selected as the mode employed for constraint generation for a particular stage.

These modes include mean, max, and min, as noted in table 600 under the floating reference section. Each mode has a different method to select a reference value (631, 633, 635), with corresponding set_min_delay and set_max_delay constraints generated based on that selected reference value. For the ‘mean’ example, a mean value of the path delays 613 for each stage is employed as the reference value (631). For the ‘max’ example, a maximum value of the path delays 613 is employed as the reference value (633). For the ‘min’ example, a minimum value of the path delays 613 is employed as the reference value (635). Resultant constraints are shown in columns 632, 634, and 636 for each reference value mode.

As shown in table 600, tracking the path delays, calculating a floating reference value, and adjusting set_min_delay and set_max_delay targets for each optimization step can help in avoiding unnecessary optimization on interface paths. Significant delay buffer reduction in the interface channels can thus be achieved to reduce the interface channel area. Thus, the reference value and resultant constraints ‘float’ or change dynamically with each stage, sub-stage, or iteration of a physical design flow. The floating reference can advantageously converge a set of paths to within a skew target across various flow stages to reach design closure. Since the reference value and constraints ‘float’ for each iteration of a design flow, then the skew target(s) can be advantageously achieved in fewer iterations or with better margins than other conventional physical design systems which might employ fixed reference values.

FIG. 7 illustrates an example computing system capable of implementing any of the physical design stages, sub-stages, or skew balancing systems discussed herein. FIG. 7 includes physical design system 700, which is representative of any system or collection of systems in which the various operational techniques, architectures, scenarios, and processes disclosed herein may be implemented. For example, physical design system 700 can be used to implement portions of physical design system 110 or skew balance module 120 of FIG. 1, any stage 411-415, sub-stage 431-442, or skew balancing system 420 of FIG. 4, or any of the tool flow, physical design, or skew balancing elements of any of the Figures herein.

Physical design system 700 may be implemented as a single apparatus, system, or device or may be implemented as multiple apparatuses, systems, or devices, including in a distributed manner. Physical design system 700 includes, but is not limited to, processing system 702, storage system 703, software 705, communication interface system 707, and user interface system 708. Processing system 702 is operatively coupled with storage system 703, communication interface system 707, and user interface system 708.

Processing system 702 loads and executes software 705 from storage system 703. When executed by processing system 702 to process circuit descriptions into physical designs across various stages, iteratively/successively apply floating reference values to path constraints, and manage skew targets, among other operations, software 705 directs processing system 702 to operate as described herein for at least the various processes, operational scenarios, and sequences discussed in the foregoing implementations. Physical design system 700 may optionally include additional devices, features, or functionality not discussed for purposes of brevity. Processing system 702 may comprise processing circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, application specific processors, graphics processing units, programmable logic devices, field-programmable logic devices, application specific integrated circuit devices, digital signal processors, and discrete logic, as well as any other type of processing device and supporting circuitry, combinations, or variations thereof.

Storage system 703 may comprise any tangible computer readable storage media readable by processing system 702 and capable of storing software 705. Storage system 703 may include volatile and nonvolatile, removable and non-removable media implemented in any method or technology for storage of information, such as computer readable instructions, data structures, control programs, program modules, or other data. Examples of storage media include random access memory, read only memory, magnetic disks, optical disks, flash memory, virtual memory and non-virtual memory, magnetic storage media, magnetic storage devices, or any other suitable storage media. In no case is the computer readable storage media a propagated signal. In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 may be implemented in program instructions and among other functions may, when executed by processing system 702, direct processing system 702 to operate as described with respect to the various operational scenarios, sequences, and processes illustrated herein. For example, software 705 may include program instructions comprising EDA environment 720 and applications 721 to implement operations 200 illustrated in FIG. 2, operations 500 illustrated in FIG. 5, or other operations discussed herein. In particular, the program instructions may include various components or modules that cooperate or otherwise interact to carry out the various processes and operational scenarios described herein. The various components or modules may be implemented in compiled or interpreted instructions, or in some other variation or combination of instructions. Software 705 may include additional processes, programs, or components, such as operating system (OS) software (e.g., 729) or other application software (e.g., 721), in addition to or that include EDA environment 720. Software 705 may also comprise firmware or some other form of machine-readable processing instructions executable by processing system 702.

Software 705, when loaded into processing system 702 and executed, may transform a suitable apparatus, system, or device (of which physical design system 700 is representative) overall from a general-purpose computing system into a special-purpose computing system customized to process circuit descriptions into physical designs across various stages, iteratively/successively apply floating reference values to path constraints, and manage skew targets, among other operations. Indeed, encoding software 705 on storage system 703 may transform the physical structure of storage system 703. For example, if the computer-readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to solid-state media, magnetic media, or optical media. Other transformations of physical media are possible without departing from the scope of the present description, with the foregoing examples provided only to facilitate the present discussion.

In one example implementation, software 705 includes EDA environment 720 comprising operating system 729 and applications 721, at least some of which are representative of the operational techniques, algorithms, architectures, scenarios, and processes discussed with respect to the included Figures. Software 705 can also employ parameters 710 stored by storage system 703. Parameters 710 can be representative of any programmable registers, software-defined parameters, status indicators, user-controlled feature settings, or adjustment parameters discussed herein. For example, parameters 710 can include indications of skew requirements or targets, applicable path identifiers, circuit descriptions, path lengths, or path length min/max constraints, among other parameters.

Applications 721 include physical design stages 722 and skew balance system 723. Skew balance system 723 includes input service 724, skew service 725, constraint service 726, and output service 726. One or more software or firmware modules can perform functions of these elements, and such modules can provide shared or distributed functionality.

Physical design stages 722 can comprise an EDA tool or physical design tool flow, among other implementations. In some examples, physical design stages 722 can simulate a circuit using one or more design tool stages, and performing timing analysis using one or more design tool stages. These stages include those described herein, such as at least one among a synthesis stage, pre-Clock Tree Synthesis (CTS) stage, CTS stage, post-CTS stage, routing stage, or post-routing stage. Physical design stages 722 can simulate a circuit to determine initial path delay values for a set of paths in the circuit, receive constraints from skew balancing system 723, and perform a timing analysis to redesign the circuit using the constraints. Physical design stages 722 can thus design or redesign a circuit based on circuit descriptions as well as skew targets, constraints, and user input. Physical design stages 722 can provide a description of a physical design to external systems for fabricating a semiconductor device including a circuit or redesigned circuit.

Skew balance system 723 can receive initial path delay values from any stage among physical design stages 722, and determine a reference value for the set of paths based on the initial path delay values, and generate constraints using the reference value and a skew target for the set of paths. These constraints can be employed by a subsequent stage among physical design stages 722 to redesign an affected circuit.

In particular, input service 724 can obtain initial path delay values with path identifiers for a set of paths in a circuit, such as from a stage of physical design stages 722. Input service 724 may condition or scale these path delay values to be of a desired metric, unit, or other property before providing the initial path delay values to skew service 725.

Skew service 725 can obtain a skew target, which can be determined based on a user input (e.g., through user interface system 708), or might be established with various configuration files, setup scripts, circuit operational requirements, design rules, or other data which indicates a skew target for a circuit, set of paths, or portion of a circuit. Skew service 725 can determine a reference value for the set of paths based on the initial path delay values, and generate constraints using the reference value and a skew target for the set of paths. In some examples, the reference value is determined using a lowest value of the initial path delay values, a mean value of the initial path delay values, or a highest value of the initial path delay values. From here, the reference value can be employed to determine path constraints which are provided to a subsequent stage among physical design stages 522. Output service 726 can provide these constraints to physical design stages 522.

Constraint service 726 can be employed to determine the path constraints based at least on the reference value determined by skew service 725. The constraints can include a minimum path delay constraint and a maximum path delay constraint. Constraint service 726 can generate the constraints by at least scaling the minimum path delay constraint or the maximum path delay constraint using the reference value and the skew target. Also, constraint service 726 can select a mode among at least a mean path delay mode, a minimum path delay mode, and a maximum path delay mode for generating the constraints. In other examples, constraint service 726 can select the minimum path delay mode responsive to a first threshold quantity of the initial path delay values being less than a mean value of the initial path delay values, and select the maximum path delay mode responsive to a second threshold quantity of the initial path delay values being greater than the mean value. For the mean path delay mode, constraint service 726 can determine the maximum path delay constraint and the minimum path delay constraint using a first range for the reference value. For the minimum path delay mode, constraint service 726 can determine the maximum path delay constraint using a second range for the reference value and determining the minimum path delay constraint using a lowest value of the initial path delay values. For the maximum path delay mode, constraint service 726 can determine the minimum path delay constraint using a third range for the reference value and determining the maximum path delay constraint using a highest value of the initial path delay values.

Communication between elements of EDA environment 720 and other systems (not shown), may occur over communication links or communication networks and in accordance with various communication protocols, combinations of protocols, or variations thereof provided by at least communication interface system 707. For example, EDA environment 720 when implementing circuit physical design system, might communicate with external processing systems, storage systems, graphics processing systems, or data systems over corresponding communication links. In other examples, EDA environment 720 might have elements, modules, or portions thereof, distributed over more than one computing system or design system, and communication links can communicatively couple such elements or modules. Communication interface system 707 might comprise elements of input service 724 or output service 725.

Example communication links employed by communication interface system 707 can include Ethernet interfaces, universal serial bus (USB) interfaces, or wireless interfaces, among others. When network links are employed, example networks include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some network communication protocols that may be used include, but are not limited to, the Ethernet, Internet protocol (IP, IPv4, IPv6, etc. . . .), the transmission control protocol (TCP), and the user datagram protocol (UDP), as well as any other suitable communication protocol, variation, or combination thereof. Communication between elements of EDA environment 720 can also be provided by communication interface system 707, such as the various inter-module or inter-element interfaces referenced herein. These interfaces can include application programming interface (API) elements, control interfaces, data interfaces, and other various communication interfaces.

User interface system 708 is optional in some implementations, and may include a software or virtual interface such as a graphical user interface (GUI), terminal interface, command line interface, or API. User interface system 708 may also include physical user interfaces, such as a keyboard, a mouse, graphical display interfaces, voice input devices, or touchscreen input devices for receiving input from a user. Output devices such as displays, web interfaces, terminal interfaces, and other types of output devices may also be included in user interface system 708. User interface system 708 can provide output and receive input over a network interface, such as communication interface system 707. In network examples, user interface system 708 might packetize data for receipt by a display system or computing system coupled over one or more network interfaces. User interface system 708 may comprise API elements for interfacing with users, other data systems, other user devices, web interfaces, and the like. User interface system 708 may also include associated user interface software executable by processing system 702 in support of the various user input and output devices discussed above. Separately or in conjunction with each other and other hardware and software elements, the user interface software and user interface devices may support a console user interface, graphical user interface, a natural user interface, or any other type of user interface.

The techniques described in this disclosure may be embodied or encoded in an article of manufacture including a non-transitory computer-readable storage medium. Example non-transitory computer-readable storage media may include random access memory (RAM), read-only memory (ROM), programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The various functional elements and interconnection architectures discussed herein are employed according to the descriptions above. However, it should be understood that the disclosures and enhancements herein are not limited to these functional elements and interconnection architectures. Thus, the descriptions and figures included herein depict specific implementations to teach those skilled in the art how to make and use the best options. For the purpose of teaching inventive principles, some conventional aspects have been simplified or omitted. Those skilled in the art will appreciate variations from these implementations that fall within the scope of this disclosure. Those skilled in the art will also appreciate that the features described above can be combined in various ways to form multiple implementations.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “path,” “pathway,” “circuit path,” and “route are used interchangeably. Unless specifically stated to the contrary, these terms are generally used to mean an interconnection between or a terminus of a device element, a circuit element, an integrated circuit, a device, or other electronics or semiconductor component. In this description, unless otherwise stated, “about,” “approximately” or “substantially” preceding a parameter means being within +/−10 percent of that parameter.

Modifications are possible in the described examples, and other examples are possible within the scope of the claims.

What is claimed is:

1. A method comprising:
simulating a circuit to determine initial path delay values for a set of paths in the circuit;
determining a reference value for the set of paths based on the initial path delay values;
generating constraints using the reference value and a skew target for the set of paths; and
performing a timing analysis to redesign the circuit using the constraints.

2. The method of claim 1, wherein the reference value is determined using:
a lowest value of the initial path delay values;
a mean value of the initial path delay values; or
a highest value of the initial path delay values.

3. The method of claim 1, wherein the circuit includes an analog subcircuit and a digital subcircuit.

4. The method of claim 1, wherein the constraints include a minimum path delay constraint and a maximum path delay constraint, and
wherein generating the constraints includes scaling the minimum path delay constraint or the maximum path delay constraint using the reference value and the skew target.

5. The method of claim 4, further comprising:
selecting a mode among at least a mean path delay mode, a minimum path delay mode, and a maximum path delay mode for generating the constraints.

6. The method of claim 5, further comprising:
for the mean path delay mode, determining the maximum path delay constraint and the minimum path delay constraint using a first range for the reference value;
for the minimum path delay mode, determining the maximum path delay constraint using a second range for the reference value and determining the minimum path delay constraint using a lowest value of the initial path delay values;
for the maximum path delay mode, determining the minimum path delay constraint using a third range for the reference value and determining the maximum path delay constraint using a highest value of the initial path delay values.

7. The method of claim 5, further comprising:
selecting the minimum path delay mode responsive to a first threshold quantity of the initial path delay values being less than a mean value of the initial path delay values; and
selecting the maximum path delay mode responsive to a second threshold quantity of the initial path delay values being greater than the mean value.

8. The method of claim 1, further comprising:
determining the skew target based on a user input.

9. The method of claim 1, further comprising:
fabricating a semiconductor device including the redesigned circuit.

10. The method of claim 1, further comprising:
simulating the circuit using a first stage of an Electronic Design Automation (EDA) tool;
performing the timing analysis using a second stage of the EDA tool;
wherein the first stage and the second stage each comprise at least one among a synthesis stage, pre-Clock Tree Synthesis (CTS) stage, CTS stage, post-CTS stage, routing stage, or post-routing stage.

11. An apparatus, comprising:
one or more non-transitory computer readable storage media;
program instructions stored on the one or more non-transitory computer readable storage media, the program instructions executable by a processing system to direct the processing system to at least:
simulate a circuit to determine initial path delay values for a set of paths in the circuit;
determine a reference value for the set of paths based on the initial path delay values;
generate constraints using the reference value and a skew target for the set of paths; and
perform a timing analysis to redesign the circuit using the constraints.

12. The apparatus of claim 11, wherein the reference value is determined using:
a lowest value of the initial path delay values;
a mean value of the initial path delay values; or
a highest value of the initial path delay values.

13. The apparatus of claim 11, wherein the constraints include a minimum path delay constraint and a maximum path delay constraint, and
comprising further instructions executable by the processing system to direct the processing system to at least:
generate the constraints by at least scaling the minimum path delay constraint or the maximum path delay constraint using the reference value and the skew target.

14. The apparatus of claim 11, comprising further instructions executable by the processing system to direct the processing system to at least:
select a mode among at least a mean path delay mode, a minimum path delay mode, and a maximum path delay mode for generating the constraints.

15. The apparatus of claim 14, comprising further instructions executable by the processing system to direct the processing system to at least:
for the mean path delay mode, determine a maximum path delay constraint and a minimum path delay constraint using a first range for the reference value;
for the minimum path delay mode, determine the maximum path delay constraint using a second range for the reference value and determine the minimum path delay constraint using a lowest value of the initial path delay values;
for the maximum path delay mode, determine the minimum path delay constraint using a third range for the reference value and determine the maximum path delay constraint using a highest value of the initial path delay values.

16. The apparatus of claim 14, comprising further instructions executable by the processing system to direct the processing system to at least:
select the minimum path delay mode responsive to a first threshold quantity of the initial path delay values being less than a mean value of the initial path delay values; and
select the maximum path delay mode responsive to a second threshold quantity of the initial path delay values being greater than the mean value.

17. The apparatus of claim 11, comprising further instructions executable by the processing system to direct the processing system to at least:
determine the skew target based on a user input.

18. The apparatus of claim 11, comprising further instructions executable by the processing system to direct the processing system to at least:
simulate the circuit using a first stage of an Electronic Design Automation (EDA) tool;
perform the timing analysis using a second stage of the EDA tool;
wherein the first stage and the second stage each comprise at least one among a synthesis stage, pre-Clock Tree Synthesis (CTS) stage, CTS stage, post-CTS stage, routing stage, or post-routing stage.

19. A method, comprising:
obtaining initial path delay values with path identifiers for a set of paths in a circuit;
determining a reference value for the set of paths based on the initial path delay values;
selecting a mean path delay mode, a minimum path delay mode, or a maximum path delay mode;
generating constraints for the selected mode using the reference value and a skew target for the set of paths, wherein the constraints include a minimum path delay constraint or a maximum path delay constraint; and
providing indications of the constraints for the path identifiers.

20. The method of claim 19, further comprising:
determining, for the mean path delay mode, the maximum path delay constraint and the minimum path delay constraint using a mean value of the initial path delay values;
determining, for the minimum path delay mode, the minimum path delay constraint using a lowest value of the initial path delay values; or
determining, for the maximum path delay mode, the maximum path delay constraint using a highest value of the initial path delay values.
